(19) United States
(12) Patent Application Publication
(10) Pub. No.: US 2022/0410352 A1
(43) Pub. Date: Dec. 29, 2022

(54) IMPACT TOOL

(71) Applicant: Panasonic Intellectual Property Management Co., Ltd., Osaka (JP)

(72) Inventors: Kimitaka OZAWA, Osaka (JP); Akiko HONDA, Osaka (JP); Takahiro UEDA, Osaka (JP); Takashi KUSAGAWA, Osaka (JP); Masaya SATO, Osaka (JP); Mitsumasa MIZUNO, Osaka (JP)

(21) Appl. No.: 17/849,039

(22) Filed: Jun. 24, 2022

(30) Foreign Application Priority Data
Jun. 28, 2021 (JP) 2021-107080

(51) Int. Cl. B25B 21/02

(52) U.S. Cl. CPC B25B 21/02

(57) ABSTRACT

An impact tool includes a motor, a hammer, and an anvil. The hammer is configured to be rotated around a rotation axis by motive power provided from the motor. The anvil is configured to be rotated around the rotation axis by receiving striking force from the hammer in a circumferential direction of the rotation axis. In the impact tool, moment of inertia of the hammer around the rotation axis is 10 or more times moment of inertia of the anvil around the rotation axis.

### CROSS-REFERENCE TO RELATED APPLICATIONS

The present application is based upon and claims the benefit of priority to Japanese Patent Application No. 2021-107080, filed on Jun. 28, 2021, the entire contents of which are incorporated herein by reference.

### TECHNICAL FIELD

The present disclosure generally relates to impact tools. The present disclosure specifically relates to an impact tool including a hammer and an anvil.

### BACKGROUND ART

JP 2005-066807 A discloses an impact rotary tool. The impact rotary tool includes: a drive shaft configured to be rotated by a motor; a hammer configured to be fit to an outer perimeter of the drive shaft in rotatable, movable forward, and movable backward manner; a hammer projection provided to the hammer; and an anvil including an anvil projection engageable with the hammer projection. In the impact rotary tool, rotation of the hammer exerts an impact on the anvil in a rotation direction, and via a socket or the like mounted on the anvil, strong torque is instantaneously given to a screw, thereby tightening the screw.

### SUMMARY

For an impact tool as the impact rotary tool described in JP 2005-066807 A, an improvement in energy efficiency may be required.

An impact tool of an aspect of the present disclosure includes a motor, a hammer, and an anvil. The hammer is configured to be rotated around a rotation axis by motive power provided from the motor. The anvil is configured to be rotated around the rotation axis by receiving striking force from the hammer in a circumferential direction of the rotation axis. Moment of inertia of the hammer around the rotation axis is 10 or more times moment of inertia of the anvil around the rotation axis.

An impact tool of an aspect of the present disclosure includes a motor, a hammer, and an anvil. The hammer is configured to be rotated around a rotation axis by motive power provided from the motor. The anvil is configured to be rotated around the rotation axis by receiving striking force from the hammer in a circumferential direction of the rotation axis. The anvil includes an anvil shaft configured to transmit the striking force to a tip tool. The impact tool is configured such that a waveform, which represents a measured torsion amount of the anvil shaft during one impact for impact operation of giving the striking force to the anvil from the hammer, has a plurality of peaks, and in the one impact, rotation energy of the hammer transmitted to the anvil after a time point at which a highest peak of the plurality of peaks is measured is greater than rotation energy of the hammer transmitted to the anvil before the time point.

### BRIEF DESCRIPTION OF THE DRAWINGS

The figures depict one or more implementation in accordance with the present teaching, by way of example only, not by way of limitations. In the figures, like reference numerals refer to the same or similar elements.

FIG. 1 is a perspective view of an impact tool of an embodiment;

FIG. 2 is a sectional view of the impact tool;

FIG. 3 is a perspective view of a main part of the impact tool;

FIG. 4 is a graph of a measured waveform of the time rate of change in the torsion amount of an anvil shaft of an impact tool of a comparative example;

FIG. 5 is a graph of energy efficiency of an impact tool;

FIG. 6 is a graph of a measured waveform of the time rate of change in the torsion amount of an anvil shaft of the impact tool of the embodiment;

FIG. 7 is a graph of a measured waveform of the time rate of change in the torsion amount of an anvil shaft of the impact tool of the embodiment;

FIG. 8 is a graph of a torque increment in one impact in the impact tool;

FIG. 9 is a graph of a torque increment in one impact in the impact tool;

FIG. 10 is a graph of a torque increment in one impact in the impact tool;

FIG. 11 is a perspective view of a main part of an impact tool of a first variation;

FIG. 12 is a sectional view of the main part of the impact tool of the first variation; and

FIG. 13 is an exploded perspective view of a main part of an impact tool of a second variation.

### DETAILED DESCRIPTION

An impact tool of the present embodiment will be described with reference to the drawings. Figures described in the following embodiment are schematic views, and therefore, the ratio of sizes and the ratio of thicknesses of components in the drawings do not necessarily reflect actual dimensional ratios.

(1) Overview

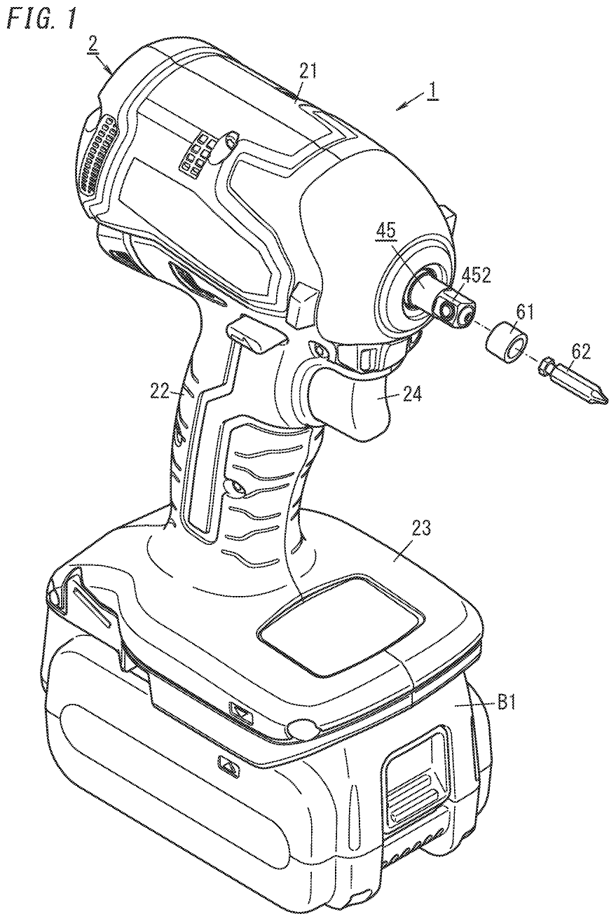

An impact tool 1 (see FIGS. 1 to 3) of the present embodiment includes a motor 3, a hammer 42, and an anvil 45. The hammer 42 is rotated around a rotation axis Ax1 by motive power provided from the motor 3. The anvil 45 is rotated around the rotation axis Ax1 by receiving striking force (rotation striking force) from the hammer 42 in a circumferential direction of the rotation axis Ax1.

In the impact tool 1 of the present embodiment, moment of inertia of the hammer 42 around the rotation axis Ax1 (i.e., with the rotation axis Ax1 being the center) is 10 or more times moment of inertia of the anvil 45 around the rotation axis Ax1 (i.e., with the rotation axis Ax1 being the center).

In the impact tool 1 of the present embodiment, energy efficiency can be improved.

(2) Details

The structure of the impact tool 1 according to the present embodiment will be described with reference to FIGS. 1 to 3.

In the following description, a direction in which the hammer 42 and the anvil 45 are aligned with each other is defined as a forward/backward direction, the side of the anvil 45 viewed from the hammer 42 is defined as a “front”, and the side of the hammer 42 viewed from the anvil 45 is defined as a “back”. That is, the anvil 45 is located forward of the hammer 42. Moreover, the direction of the rotation axis Ax1 of the hammer 42 and the anvil 45 is along the forward/backward direction. Moreover, in the following description, a direction in which a body 21 and a grip 22 described later are aligned with each other is defined as an up/down direction, the side of the body 21 when viewed from the grip 22 is defined as upward, and the side of the grip 22 when viewed from the body 21 is defined as downward. Note that the directions are merely defined for the sake of explanation of the positional relationship between components of the impact tool 1 but do not intend to limit directions in which the impact tool 1 is used.

The impact tool 1 of the present embodiment is a portable electric tool. The impact tool 1 is, for example, an impact driver or an impact wrench.

The impact tool 1 operates with power supplied from a battery pack B1. The battery pack B1 is a power supply that supplies a current for driving the motor 3. The battery pack B1 is not a component of the impact tool 1. Note that the impact tool 1 may include the battery pack B1 as one of components thereof. The battery pack B1 includes: an assembled battery including a plurality of secondary batteries (e.g., lithium ion batteries) connected in series; and a case in which the assembled battery is housed.

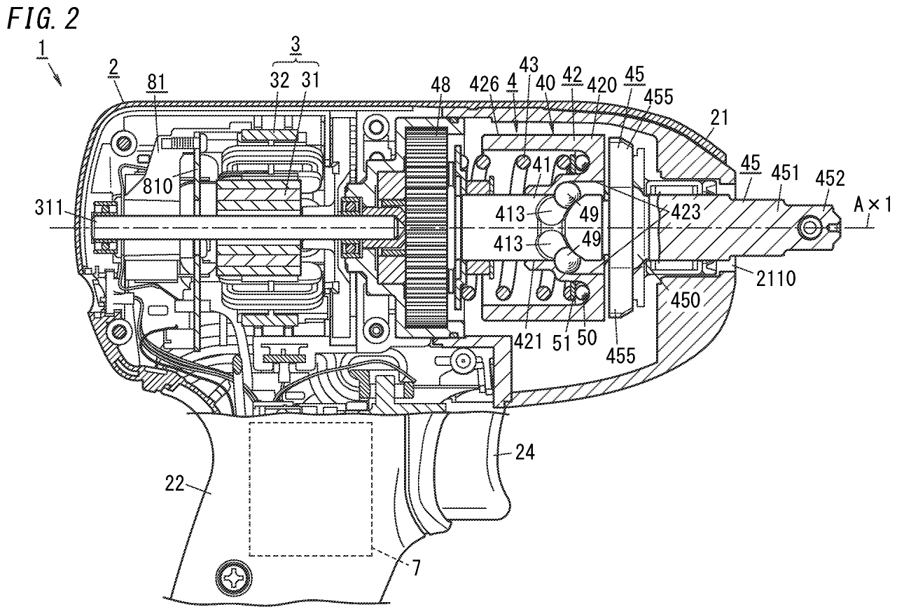

As shown in FIGS. 1 and 2, the impact tool 1 includes a housing 2, the motor 3, a transmission mechanism 4, an operating part 24, and a controller 7.

The housing 2 houses the motor 3, part of the transmission mechanism 4, and the controller 7.

The housing 2 includes the body 21, the grip 22, and a fitting part 23.

The body 21 has a tubular shape with its tip end (front end) having an opening (through hole 2110) and with its rear end having a bottom.

The grip 22 protrudes downward from a side surface of the body 21.

The battery pack B1 is detachably attached to the fitting part 23. In the present embodiment, the fitting part 23 is provided at a tip end part (lower end part) of the grip 22.

The operating part 24 is provided at an upper end part of the grip 22 to protrude forward. The operating part 24 includes, in this embodiment, a trigger controller configured to receive, from a user, an operation for controlling rotation of the motor 3. An operation (backward pulling operation) of pulling the operating part 24 enables the motor 3 to be switched on from off. Moreover, the rotational speed of the motor 3 is adjustable by pulled amount of the operating part 24 indicating how deep the operating part 24 is pulled. As the pulled amount increases, the rotational speed of the motor 3 increases.

The motor 3 is, for example, a brushless motor. The motor 3 includes: a rotor 31 including a rotary shaft 311 and a permanent magnet; and a stator 32 including a coil. The motor 3 is disposed at a relatively rear part in an interior space of the body 21. The motor 3 converts electric power supplied from the battery pack B1 (see FIG. 1) into rotary drive force of the rotary shaft 311.

As shown in FIG. 2, a drive circuit block 81 is disposed behind the motor 3 in the body 21. The drive circuit block 81 includes a substrate 810 and a plurality of electronic components mounted on the substrate 810. The plurality of electronic components include a plurality of power elements that constitute an inverter circuit. Each power element is, for example, a Field Effect Transistor (FET) element.

The controller 7 controls operation of the motor 3. The controller 7 rotates or stops the motor 3 and controls the rotational speed of the motor 3 in accordance with the pulled amount of the operating part 24. The controller 7 switches on and off the plurality of FET elements of the drive circuit block 81, thereby controlling electric power supplied to the motor 3 via the plurality of FET elements (inverter circuit).

The transmission mechanism 4 is located forward of the motor 3 in the internal space of the body 21. The transmission mechanism 4 includes an impact mechanism 40 and a planet gear mechanism 48.

The impact mechanism 40 includes a drive shaft (spindle) 41, the hammer 42, a return spring 43, the anvil 45, and two steel balls 49 (rolling elements).

The planet gear mechanism 48 is a deceleration device. The torque of the rotary shaft 311 of the motor 3 is transmitted via the planet gear mechanism 48 to the drive shaft 41. Thus, the drive shaft 41 is rotated around the rotation axis Ax1 by motive power provided from the motor 3. The torque of the drive shaft 41 is transmitted to the hammer 42. Thus, the hammer 42 rotates around the rotation axis Ax1. The torque of the hammer 42 is transmitted to the anvil 45. Thus, the anvil 45 rotates around the rotation axis Ax1.

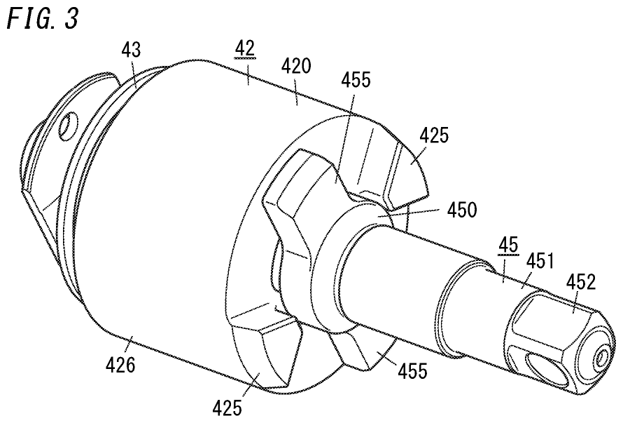

As shown in FIGS. 2 and 3, the hammer 42 includes a hammer body 420, two hammer projections 425, and a skirt part 426.

The hammer body 420 has a columnar shape. The two hammer projections 425 protrude from a surface (front surface), facing the anvil 45, of the hammer body 420. The hammer projections 425 are pillars in the shape of a fan in front view. The skirt part 426 has a cylindrical shape and protrudes backward from a peripheral part of a rear surface of the hammer body 420. As shown in FIG. 2, a rear end of the skirt part 426 is located backward of the other portions of the hammer 42. Thus, the hammer 42 has a peripheral edge part thicker than a center part of the hammer 42 in the forward/backward direction (a direction along the axis line of the rotation axis Ax1). The hammer 42 includes the skirt part 426 and thus has greater moment of inertia around the rotation axis Ax1 than a hammer of an impact tool of a comparative example including no skirt part 426.

The hammer body 420 has a through hole 421 at the center thereof, and the drive shaft 41 is inserted in the through hole 421. The hammer body 420 has, in its inner peripheral surface defining the through hole 421, two groove parts 423 extending in V shape in the forward/backward direction. The drive shaft 41 has, in its outer peripheral surface, two groove parts 413 extending in V shape in the forward/backward direction. The two groove parts 413 are continuous.

The two steel balls 49 are disposed between the two groove parts 423 and the two groove parts 413. The two groove parts 423, the two groove parts 413, and the two steel balls 49 constitute a cam mechanism.

While the two steel balls 49 move in the groove parts 423 and 413, the hammer 42 is movable, with respect to the drive shaft 41, in the direction (forward/backward direction) of the rotation axis Ax1 and is rotatable with respect to the drive shaft 41. As the hammer 42 moves toward an anvil shaft 451 or away from the anvil shaft 451 along the direction of axis of the drive shaft 41, the hammer 42 rotates with respect to the drive shaft 41. That is, the hammer 42 is coupled to an outer peripheral surface of the drive shaft 41 to be movable in the forward/backward direction (direction along the axis line of the rotation axis Ax1) and rotates around the rotation axis Ax1 along with the rotation of the drive shaft 41.

As shown in FIGS. 2 and 3, the anvil 45 includes an anvil body 450, the anvil shaft 451, a fitting part 452, and two anvil projections 455.

The anvil body 450 has an annular shape. The anvil body 450 is located forward of the hammer body 420. The anvil body 450 faces the hammer body 420 in the forward/backward direction such that the axis line of the anvil body 450 coincides with the axis line of the hammer body 420.

Each of the two anvil projections 455 is in the shape of a rectangular parallelepiped. The two anvil projections 455 are connected to the anvil body 450. The two anvil projections 455 protrude from the anvil body 450 in a radial direction of the anvil body 450.

The anvil shaft 451 has a columnar shape. The anvil shaft 451 also protrudes from the anvil body 450 in the axis direction of the anvil body 450. The anvil shaft 451 protrudes forward from the anvil body 450. As shown in FIG. 2, the anvil shaft 451 is inserted in the through hole 2110 formed in the housing 2. The anvil shaft 451 has a tip end exposed outside the housing 2.

The tip end (front end) of the anvil shaft 451 has the fitting part 452 provided integrally with the anvil shaft 451. The fitting part 452 has a quadrangular prism shape. The fitting part 452 rotates along with rotation of the anvil 45. To the fitting part 452, a tip tool 62 is to be detachably attached. For example, a tip end surface (front end surface) of the fitting part 452 has a recess having a hexagonal prism shape, and in the recess, a rear end having a hexagonal prism shape of the tip tool 62 is fit.

In the present embodiment, the tip tool 62 is coupled to the fitting part 452 via a chuck 61 (see FIG. 1). The anvil 45 receives torque from the motor 3 to rotate around the rotation axis Ax1 together with the chuck 61 and the tip tool 62.

Neither the chuck 61 nor the tip tool 62 is a component of the impact tool 1. Note that the impact tool 1 may include at least one of the chuck 61 or the tip tool 62 as its component.

The tip tool 62 is fit to a fastening member (e.g., a screw or a bolt) which is a work target. A fastening member can be tightened or loosen by the rotating the tip tool 62 fitted to the fastening member.

The tip tool 62 is, for example, a driver bit. A tip end of the driver bit is fit in a cross hole or groove formed in the head of a screw as the fastening member, and thereby, the driver bit is fit to the screw. The tip tool 62 is not limited to the driver bit but may be, for example, a socket. The socket has, in its tip end (front end), a recess having a hexagonal prism shape, and in the recess, the head of a bolt as the fastening member is fit, and thereby, the socket is fit in the bolt.

In the impact tool 1 of the present embodiment, the tip tool 62 for tightening or loosening a fastening member smaller than or equal to M8 or smaller than or equal to 5/16 inches is attachable to the fitting part 452. That is, the impact tool 1 of the present embodiment is a tool for tightening a small fastening member. In such an impact tool 1, an increase in the size of the housing 2 (the size of the body 21) does not tend to be desired from the viewpoint of usability, portability, and the like.

As shown in FIG. 2, the return spring 43 is sandwiched between the hammer 42 and the planet gear mechanism 48. The return spring 43 of the present embodiment is a cone coil spring.

The impact mechanism 40 further includes a plurality of spherical bodies (steel balls 50) (only two of which are shown in FIG. 2) and a ring 51 between the hammer 42 and the return spring 43. Thus, the hammer 42 is rotatable with respect to the return spring 43. The hammer 42 receives forward force from the return spring 43 via the spherical bodies and the ring 51.

When the impact mechanism 40 does not perform impact operation, the hammer 42 and the anvil 45 together rotate around the rotation axis Ax1 with the two hammer projections 425 being in contact with the two anvil projections 455. Thus, at this time, the hammer 42, the anvil 45, and the tip tool 62 rotate together.

The impact mechanism 40 performs the impact operation when a torque condition is satisfied, where the torque condition relates to the magnitude of a load torque, and the load torque refers to the torque applied to the anvil shaft 451. The impact operation is operation of applying striking force from the hammer 42 to the anvil 45. In the present embodiment, the torque condition is that the load torque is greater than or equal to a prescribed value. That is, as the load torque increases, a force component, contained in force generated between the hammer 42 and the anvil 45, which moves the hammer 42 backward increases. When the load torque comes to have a prescribed value or greater, the hammer 42 moves backward while compressing the return spring 43. Then, this backward movement of the hammer 42 rotates the hammer 42 while the two hammer projections 425 of the hammer 42 climb over the two anvil projections 455 of the anvil 45. The hammer 42 then moves forward by return force applied from the return spring 43. When the drive shaft 41 makes a substantially half turn, the two hammer projections 425 of the hammer 42 collide with the two anvil projections 455 of the anvil 45, and the hammer 42 applies rotation striking force (impact force) to the anvil 45. Each time the drive shaft 41 in the impact mechanism 40 makes a substantially half turn, the hammer projections 425 collide with the anvil projections 455, and thereby, the hammer 42 applies the rotation striking force to the anvil 45. That is, each time the drive shaft 41 makes a substantially half turn, the hammer 42 applies pulsed rotation striking force to the anvil 45.

As described above, the hammer 42 in the impact mechanism 40 repeatedly applies the rotation striking force to the anvil 45 in the impact operation. In the impact tool 1, a fastening member such as a screw can be more strongly tightened with torque resulting from the rotation striking force than in an electric tool which does not perform the impact operation.

The inventors of the present application found that in such an impact tool 1, clearances (backlash) may be formed between the anvil 45 and the tip tool 62 and between the tip tool 62 and the fastening member and these clearances may reduce the energy efficiency of the impact tool 1. Here, the energy efficiency is, for example, defined as a ratio of energy used to tighten the fastening member to the rotation energy of the hammer 42 in one impact which is the operation that the hammer 42 applies pulsed rotation striking force to the anvil 45 once.

This will be described below.

The inventors of the present application first of all used an impact tool of a comparative example and measured tightening force (tightening torque) which the tip tool 62 applied to the fastening member to tighten the fastening member by the impact tool of the comparative example. The impact tool of the comparative example has a structure similar to the impact tool 1 of the embodiment. However, the hammer 42 of the impact tool of the comparative example includes no skirt part 426, and the moment of inertia of the hammer 42 around the rotation axis Ax1 is five times the moment of inertia of the anvil 45 around the rotation axis Ax1.

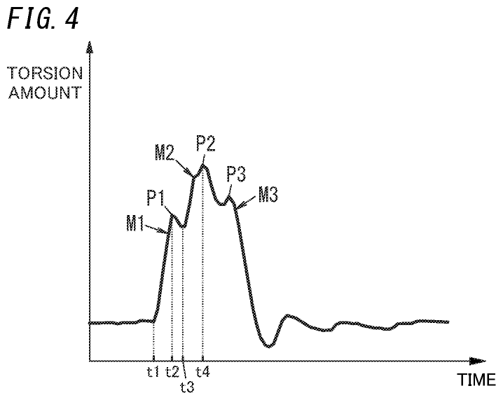

FIG. 4 shows a waveform indicating a change with time of the torsion amount of the anvil shaft 451, in one impact, measured for the impact tool of the comparative example. The torsion amount of the anvil shaft 451 is measurable by a distortion sensor disposed to, for example, the anvil shaft 451.

In the impact tool, when the impact mechanism 40 performs the impact operation, collision of the hammer 42 with the anvil 45 results in that the anvil shaft 451 of the anvil 45 gives to the tip tool 62 impact force around the rotation axis Ax1. Then, the anvil shaft 451 receives reaction force in the circumferential direction of the rotation axis Ax1 from the tip tool 62 and is twisted around the rotation axis Ax1 by the reaction force. The anvil shaft 451 thus twisted returns to its initial state, thereby giving force around the rotation axis Ax1 to the tip tool 62. Thus, it can be said that the torsion amount of the anvil shaft 451 (the ordinate in FIG. 4) represents the magnitude of force applied from the anvil 45 to the tip tool 62, and consequently, represents the magnitude of the tightening force which the tip tool 62 applies to the fastening member to tighten the fastening member.

As can be seen from FIG. 4, a measured waveform indicating a change with time of the torsion amount of the anvil shaft 451 includes a plurality of mountains M1 to M3 respectively having peaks (local maximum values) P1 to P3. This shows that due to the clearances (backlash), the hammer 42 and the anvil 45 collide with each other for a plurality of number of times during one impact.

That is, in the impact tool, the operation as described below is performed in one impact.

First of all, the hammer projections 425 climb over the anvil projections 455, the hammer 42 rotates around the rotation axis Ax1 in one direction (hereinafter, this direction is referred to as a “first direction”), and the hammer projections 425 collide with the anvil projections 455 on an opposite side (first collision).

According to the impact of the first collision, the anvil 45 rotates in the first direction at a speed higher than the speed of the hammer 42 to close up the clearance between the anvil 45 and the tip tool 62, thereby colliding with the tip tool 62 (time point t1). In the anvil 45, reaction force of the collision with the tip tool 62 causes torsion of the anvil shaft 451 around the rotation axis Ax1, thereby increasing the torsion amount.

According to the impact of the collision with the anvil 45, the tip tool 62 rotates in the first direction at a speed higher than that of the anvil 45 to close up the clearance between the tip tool 62 and the fastening member and collides with the fastening member. The impact of the collision tightens the fastening member in the first direction.

When the tip tool 62 collides with the fastening member, the tip tool 62 receives, from the fastening member, reaction force in a direction opposite to the first direction (hereinafter this direction is referred to as a “second direction”), is thus decelerated, and then collides with the anvil 45 rotating in the first direction (time point t2). The anvil 45 collides with the tip tool 62, thereby receiving force in the second direction from the tip tool 62, which reduces the torsion amount of the anvil shaft 451. Moreover, the rotational speed in the first direction of the anvil 45 is reduced by the collision with the tip tool 62. Then, the anvil projections 455 of the anvil 45 collide again (second collision) with the hammer projections 425 of the hammer 42 rotating in the first direction.

According to the impact of the second collision, the anvil 45 is accelerated again in the first direction and collides with the tip tool 62 (time point t3). In the anvil 45, reaction force of the collision with the tip tool 62 causes torsion of the anvil shaft 451 around the rotation axis Ax1, thereby increasing the torsion amount.

The tip tool 62 is accelerated in the first direction by the collision with the anvil 45 and collides with the fastening member. The impact of the collision tightens the fastening member in the first direction.

Hereafter, the collision is repeated between the components, thereby tightening the fastening member.

As can be seen from FIG. 4, in the impact tool, the peak P2 at the time of the second collision is higher than the peak P1 at the time of the first collision in one impact. The reason for this is that in the first collision, the energy of the anvil 45 is consumed, for example, for closing up the clearances, and therefore, the peak P2 at the time of the second collision is higher than the peak P1 at the time of the first collision.

Here, in the impact tool, in one impact, force that mainly contributes to tightening of the fastening member is force applied to the fastening member at and after a time point at which the force applied to the fastening member becomes maximum, that is, at and after a time point at which the torsion amount of the anvil shaft 451 is maximum. For example, in the example shown in FIG. 4, a great tightening force is applied to the fastening member at the time point t4, which is greater than tightening force applied to the fastening member prior to the time point t4. Thus, the tightening force applied to the fastening member before the time point t4 is “overwritten” with the tightening force at the time point t4 and thus makes a small contribution to tightening of the fastening member.

In sum, in the impact tool, due to existence of the clearances, energy given from the hammer 42 to the anvil 45 by the first collision in one impact is consumed without contributing to tightening of the fastening member.

Based on the knowledge, the inventors of the present application found that in the impact tool 1, increasing the ratio of the moment of inertia of the hammer 42 around the rotation axis Ax1 to the moment of inertia of the anvil 45 around the rotation axis Ax1 (hereinafter also referred to as an “inertia ratio”) improves the energy efficiency.

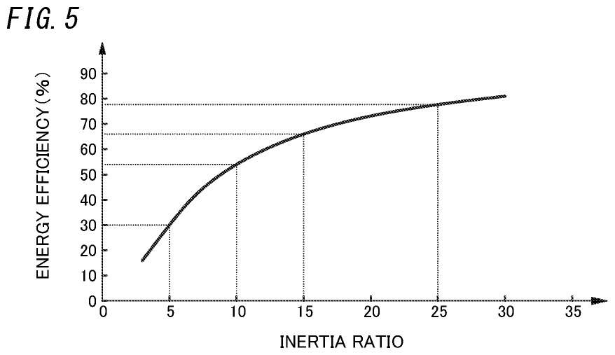

FIG. 5 shows a graph of a simulation result of a calculation of the energy efficiency [%] of the impact tool 1 when the inertia ratio is varied.

In the example shown in FIG. 5, a simulation is performed provided that the following operation is performed in one impact. That is, the hammer 42 at first collides with the anvil 45, and as a result of the collision, the anvil 45 rotates in the first direction at a speed higher than that of the hammer 42, and the anvil 45 thus collides with the tip tool 62, and as a result of this collision, the tip tool 62 rotates in the first direction at a speed higher than that of the anvil 45, and the tip tool 62 thus collides with the fastening member. The collision of the tip tool 62 with the fastening member rotates the tip tool 62 in the second direction, and the tip tool 62 thus collides with the anvil 45, and as a result of the collision, the anvil 45 rotates in the second direction and collides with the hammer 42. As a result of the collision, the anvil 45 rotates in the first direction at a speed higher than (substantially the same as) the speed of the hammer 42, and the anvil 45 thus collides with the tip tool 62, and as a result of this collision, the tip tool 62 rotates in the first direction at a speed higher than (substantially the same as) the speed of the anvil 45, and the tip tool 62 thus collide with the fastening member. As a result, the hammer 42, the anvil 45, and the tip tool 62 rotate together and tighten the fastening member. In this simulation, the “energy efficiency” is calculated as the ratio of: energy of the hammer 42 at the time of the second collision of the hammer 42 with the anvil 45, that is, energy consumed by the second and following collisions; to rotation energy which the hammer 42 initially has (rotation energy which the hammer 42 has at the time of the first collision with the anvil 45). Note that in this simulation, the rotation energy which the hammer 42 initially has is constant (same as each other). Note that the relationship between the inertia ratio and the energy efficiency shown in FIG. 5 is also experimentally confirmed by the inventors of the present application.

From FIG. 5, it can be seen that in the case where the inertia ratio is 5, (i.e., in the case of the impact tool of the comparative example shown in FIG. 4), the energy efficiency is about 30%. That is, it can be seen that in the impact tool of the comparative example, about 70% of the rotation energy which the hammer 42 initially has is consumed without contributing to tightening of the fastening member.

Moreover, it can be seen from FIG. 5 that as the inertia ratio increases, the energy efficiency is improved, and in the case where the inertia ratio is 10, the energy efficiency is higher than or equal to 50%. In sum, it can be seen that an inertia ratio of 10 or greater enables a half or more of the rotation energy which the hammer 42 initially has to be used to tighten the fastening member, thereby improving the energy efficiency.

Moreover, it can be seen from FIG. 5 that in the case where the inertia ratio is 15, the energy efficiency is higher than or equal to 65%, and in the case where the inertia ratio is 25, the energy efficiency is higher than or equal to 75%, which indicate that the energy efficiency is further improved.

In sum, increasing the inertia ratio enables the ratio of energy consumed by the first collision to be reduced, and the energy efficiency to be improved.

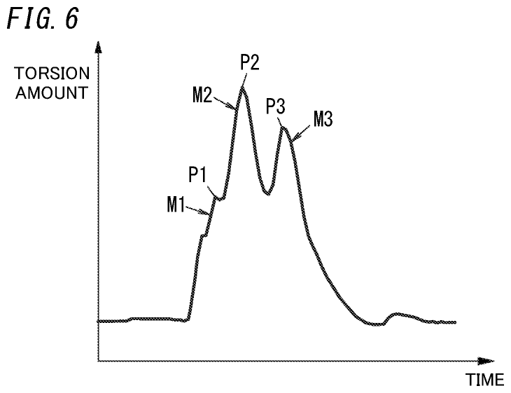

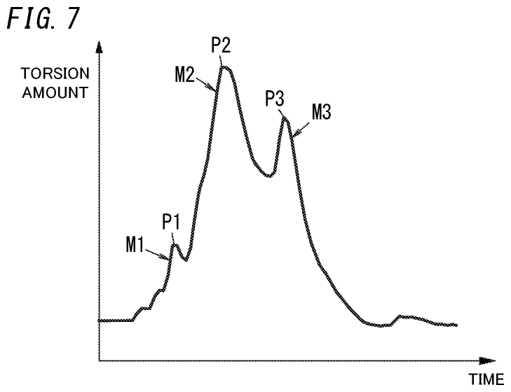

FIGS. 6 and 7 show, for the impact tool 1 in the cases of the inertia ratio being 15 and 25 respectively, waveforms of a result of measurement of the change with time of the torsion amount of the anvil shaft 451 in one impact. FIG. 6 shows a measured waveform of the impact tool 1 in the case of the inertia ratio being 15. FIG. 7 shows a measured waveform of the impact tool 1 in the case of the inertia ratio being 25. Note that in FIGS. 4, 6, and 7, the scale on the ordinate and the scale on the abscissa are the same. Moreover, in FIGS. 4, 6, and 7, a measurement condition is that the rotation energy which the hammer 42 initially has is constant (same as each other).

It can be seen from FIGS. 4, 6, and 7 that as the inertia ratio increases, the ratio of the peak P2 at the time of the second collision to the peak P1 at the time of the first collision increases. Moreover, it can be seen from FIGS. 4, 6, and 7 that as the inertia ratio increases, the maximum value (magnitude of the peak P2) of the torsion amount of the anvil shaft 451 increases, which indicates that the fastening member is tightened with increased tightening force. Moreover, it can be seen from FIGS. 4, 6, and 7 that as the inertia ratio increases, a time period during which the anvil shaft 451 is twisted increases, which indicates that tightening force is applied to the fastening member for a long period of time. In sum, it can be seen that as the inertia ratio increases, “impulse” applied from the anvil shaft 451 to the tip tool 62 increases, and the fastening member is thus efficiently tightened.

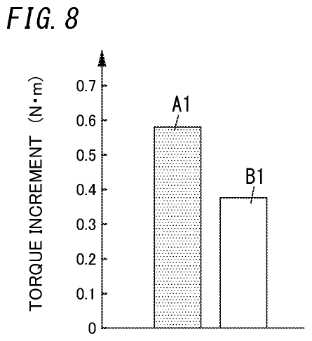

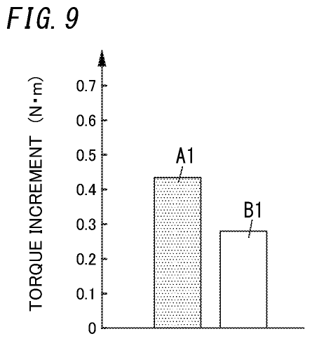

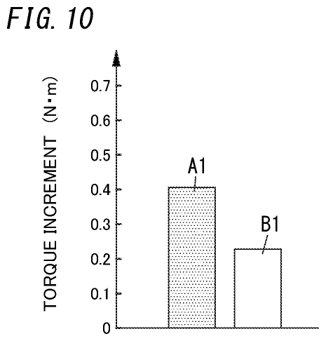

FIGS. 8 to 10 show measurement results of the increment of the tightening torque when one impact is made. FIG. 8 shows a measurement result of the increment of the tightening torque when the tightening torque of a bolt as the fastening member is 15 N·m (i.e., when the bolt is already tightened with a tightening torque of 15 N·m). FIG. 9 shows a measurement result of the increment of the tightening torque when the tightening torque of a bolt as the fastening member is 20 N·m. FIG. 10 shows a measurement result of the increment of the tightening torque when the tightening torque of a bolt as the fastening member is 25 N·m. In each of FIGS. 8 to 10, a graph denoted by A1 shows a measurement result using the impact tool 1 having the inertia ratio of 25, whereas a graph denoted by B1 shows a measurement result of an impact tool of a comparative example having the inertia ratio of 5. In FIGS. 8 to 10, a measurement condition is that the rotation energy which the hammer 42 initially has is constant.

For example, when the tightening torque of a bolt is 20 N·m (see FIG. 9), the increment of the tightening torque is 0.23 N·m in the impact tool of the comparative example having the inertia ratio of 5, whereas the increment of the tightening torque is 0.41 N·m in the impact tool 1 having the inertia ratio of 25. Thus, increasing the inertia ratio can increase the increment of the tightening torque of a bolt in one impact. In sum, increasing the inertia ratio improves the energy efficiency which is the ratio of energy used to tighten the fastening member to the rotation energy of the hammer 42.

Thus, in the impact tool 1 of the present embodiment, the inertia ratio (ratio of moment of inertia of the hammer 42 around the rotation axis Ax1 to the moment of inertia of the anvil 45 around the rotation axis Ax1) is 10 or greater, and therefore, the energy efficiency can be improved. Moreover, an improvement in the energy efficiency can reduce the ratio of energy consumed as a sound or heat to the rotation energy which the hammer 42 initially has. Thus, the impact tool 1 of the present embodiment can reduce noise generated from the impact tool 1 and can reduce heat generated from the impact tool 1.

Moreover, in the impact tool 1 of the present embodiment, the hammer 42 is provided with the skirt part 426, thereby increasing the moment of inertia of the hammer 42 around the rotation axis Ax1. Thus, the moment of inertia of the hammer 42 around the rotation axis Ax1 can be increased while the size of the hammer 42 in its radial direction is suppressed, and consequently, the size of the housing 2 is suppressed.

(3) Variation

The embodiment described above is merely an example of various embodiments of the present disclosure. Various modifications may be made to the embodiment depending on design and the like as long as the object of the present disclosure is achieved. Variations of the embodiment described above will be enumerated below. The variations described below are applicable accordingly in combination.

(3.1) First Variation

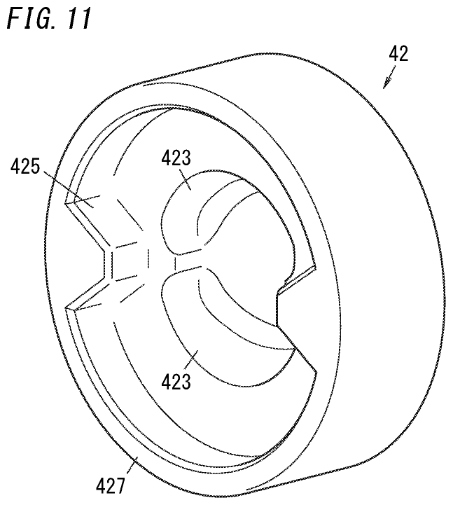

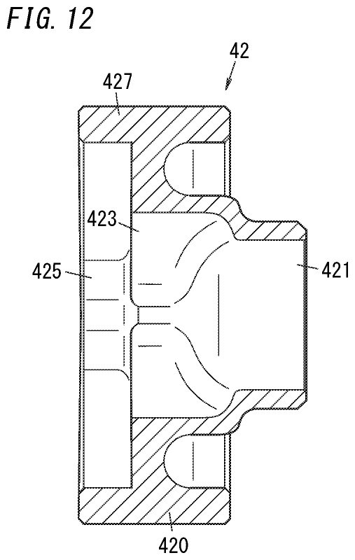

In the present variation, a hammer 42 has an edge part 427 as shown in FIGS. 11 and 12. The edge part 427 is provided at an outer periphery of a hammer body 420. The edge part 427 is cylindrical and protrudes as far as front surfaces of hammer projections 425 in the forward/backward direction. Since the hammer 42 has the edge part 427, the moment of inertia of the hammer 42 around the rotation axis Ax1 can be increased while the size of the hammer 42 in its radial direction is suppressed.

Note that the edge part 427 may protrude forward farther than the hammer projections 425.

Moreover, in the present variation, as shown in FIG. 12, the hammer 42 includes no skirt part 426, and the thickness of the hammer 42 is smaller in its peripheral part than in its center part in the forward/backward direction. However, this should not be construed as limiting, but the hammer 42 may further include the skirt part 426. The moment of inertia of the hammer 42 around the rotation axis Ax1 can be further increased while the size of the hammer 42 in its radial direction is suppressed.

(3.2) Second Variation

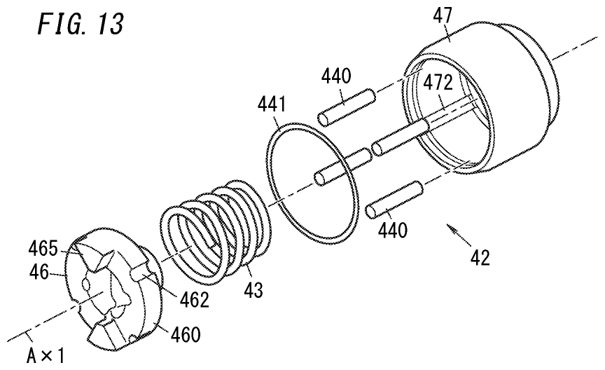

In the present variation, a hammer 42 includes a main hammer 46 and a sub-hammer 47 as shown in FIG. 13. The main hammer 46 is coupled to an outer peripheral surface of a drive shaft 41 (see FIG. 2) to be movable in the forward/backward direction (direction along the axis line of the rotation axis Ax1). The main hammer 46 rotates around the rotation axis Ax1 along with the rotation of the drive shaft 41. The sub-hammer 47 is restricted from moving in the forward/backward direction. The sub-hammer 47 is coupled to the main hammer 46 to rotate together with the main hammer 46 as the main hammer 46 rotates around the rotation axis Ax1.

More specifically, the main hammer 46 includes a main hammer body 460, hammer projections 465, and groove parts in a similar manner to the hammer 42 of the embodiment.

The sub-hammer 47 has a hollow cylindrical shape and is configured to house the main hammer 46 therein. The sub-hammer 47 has an inner peripheral surface having four pin grooves 472 which extend in the direction of the rotation axis Ax1 and which are formed at an interval of 90 degrees. Into the four pin groove 472, four pins 440 which are columnar are to be fit. In this state, a stop member 441 which is annular is fit in a groom formed in a front edge of the sub-hammer 47, so that the pins 440 do not fall off the pin grooves 472.

On the other hand, the main hammer body 460 has an outer peripheral surface having four pin grooves 462 which extend in the axis direction of the rotation axis Ax1 and which are formed at an interval of 90 degrees. The main hammer 46 is disposed in the sub-hammer 47 such that the four pins 440 are fit in the four pin grooves 462. Thus, the main hammer 46 is held by the sub-hammer 47 such that the main hammer 46 and the sub-hammer 47 are rotatable together around the rotation axis Ax1 and the main hammer 46 is movable with respect to the sub-hammer 47 in the forward/backward direction.

When the main hammer 46 performs the impact operation, the main hammer 46 rotates around the rotation axis Ax1 while moving in the forward/backward direction in a manner similar to the hammer 42 of the embodiment, and the main hammer 46 collides with the anvil 45 to apply rotation striking force to the anvil 45. On the other hand, the sub-hammer 47 is restricted by the housing 2 from moving in the forward/backward direction, and thus, the sub-hammer 47 rotates around the rotation axis Ax1 together with the main hammer 46, but the sub-hammer 47 does not move in the forward/backward direction.

In the present variation, the sum of the moments of inertia of the main hammer 46, the sub-hammer 47, the four pins 440, and the stop member 441 around the rotation axis Ax1 is 10 or more times the moment of inertia of the anvil 45 around the rotation axis Ax1.

In the present variation, since the hammer 42 includes the sub-hammer 47, the moment of inertia of the hammer 42 around the rotation axis Ax1 can be increased while the size of the hammer 42 in its radial direction is suppressed.

Note that the moment of inertia of only the main hammer 46 around the rotation axis Ax1 may be 10 or more times the moment of inertia of the anvil 45 around the rotation axis Ax1.

(3.3) Other Variations

In a variation, the hammer 42 does not have to include the skirt part 426. Alternatively, the density (mass per unit volume) of a peripheral edge part of the hammer 42 may be higher than the density of the center part of the hammer 42 such that the inertia ratio is 10 or greater. For example, the peripheral edge part and the center part of the hammer 42 may be made of materials having different densities and may be integrated with each other by welding or the like.

(4) Aspects

As can be seen from the embodiment and the variations described above, the present specification discloses the following aspects.

An impact tool (1) of a first aspect includes a motor (3), a hammer (42), and an anvil (45). The hammer (42) is configured to be rotated around a rotation axis (Ax1) by motive power provided from the motor (3). The anvil (45) is configured to be rotated around the rotation axis (Ax1) by receiving striking force from the hammer (42) in a circumferential direction of the rotation axis (Ax1). In the impact tool (1), moment of inertia of the hammer (42) around the rotation axis (Ax1) is 10 or more times moment of inertia of the anvil (45) around the rotation axis (Ax1).

With this aspect, energy efficiency is improved.

An impact tool (1) of a second aspect referring to the first aspect further includes a fitting part (452). The fitting part (452) is configured to rotate along with rotation of the anvil (45). A tip tool (62) is attachable to the fitting part (452). The tip tool (62) is configured to tighten or loosen a fastening member smaller than or equal to M8 or smaller than or equal to 5/16 inches.

With this aspect, the energy efficiency of the impact tool (1) is improved while the impact tool (1) is small in size.

In an impact tool (1) of a third aspect referring to the first or second aspect, the hammer (42) is coupled to an outer peripheral surface of a drive shaft (41) to be movable in a direction along an axis line of the rotation axis (AU). The drive shaft (41) is configured to be rotated around the rotation axis (Ax1) by the motive power provided from the motor (3). The hammer (42) is configured to be rotated around the rotation axis (Ax1) along with rotation of the drive shaft (41).

With this aspect, energy efficiency is improved.

In an impact tool (1) of a fourth aspect referring to the first or second aspect, the hammer (42) includes a main hammer (46) and a sub-hammer (47). The main hammer (46) is coupled to an outer peripheral surface of a drive shaft (41) to be movable in a direction along an axis line of the rotation axis (Ax1). The drive shaft (41) is configured to be rotated around the rotation axis (Ax1) by the motive power provided from the motor (3). The main hammer (46) is configured to be rotated around the rotation axis (Ax1) along with rotation of the drive shaft (41). The sub-hammer (47) is restricted from moving in the direction along the axis line of the rotation axis (Ax1). The sub-hammer (47) is coupled to the main hammer (46) to rotate together with the main hammer (46) as the main hammer (46) rotates around the rotation axis (Ax1).

With this aspect, energy efficiency is improved.

In an impact tool (1) of a fifth aspect referring to any one of the first to fourth aspects, the hammer (42) has a peripheral edge part thicker than a center part of the hammer (42) in a direction along an axis line of the rotation axis (Ax1).

With this aspect, the moment of inertia of the hammer (42) is increased while the size of the hammer (42) in its radial direction is suppressed.

In an impact tool (1) of a sixth aspect referring to any one of the first to fifth aspects, the hammer (42) includes a hammer body (420) and a hammer projection (425) protruding from a front surface of the hammer body (420). The front surface faces the anvil (45). The anvil (45) includes an anvil body (450) located forward of the hammer body (420) and an anvil projection (455) connected to the anvil body (450) and configured to collide with the hammer projection (425) in a rotation direction of the hammer (42). The hammer (42) further includes an edge part (427) at an outer periphery of the hammer body (420), the edge part (427) protruding forward as far as a front surface of the hammer projection (425) or protruding forward farther than the hammer projection (425).

With this aspect, the moment of inertia of the hammer (42) is increased while the size of the hammer (42) in its radial direction is suppressed.

An impact tool (1) of a seventh aspect includes a motor (3), a hammer (42), and an anvil (45). The hammer (42) is configured to be rotated around a rotation axis (Ax1) by motive power provided from the motor (3). The anvil (45) is configured to be rotated around the rotation axis (Ax1) by receiving striking force from the hammer (42) in a circumferential direction of the rotation axis (Ax1). The anvil (45) includes an anvil shaft (451) configured to transmit the striking force to a tip tool (62). The impact tool (1) is configured such that a waveform, which represents a measured torsion amount of the anvil shaft (451) during one impact for impact operation of giving the striking force to the anvil (45) from the hammer (42), has a plurality of peaks (P1, P2, P3), and such that in the one impact, rotation energy of the hammer (42) transmitted to the anvil (45) after a time point (t4) at which a highest peak (P2) of the plurality of peaks (P1, P2, P3) is measured is greater than rotation energy of the hammer (42) transmitted to the anvil (45) before the time point (t4).

With this aspect, energy efficiency is improved.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. An impact tool comprising:
a motor;
a hammer configured to be rotated around a rotation axis by motive power provided from the motor; and
an anvil configured to be rotated around the rotation axis by receiving striking force from the hammer in a circumferential direction of the rotation axis,
moment of inertia of the hammer around the rotation axis being 10 or more times moment of inertia of the anvil around the rotation axis.

2. The impact tool of claim 1, further comprising a fitting part configured to rotate along with rotation of the anvil, a tip tool being attachable to the fitting part, the tip tool being configured to tighten or loosen a fastening member smaller than or equal to M8 or smaller than or equal to 5/16 inches.

3. The impact tool of claim 1, wherein
the hammer is coupled to an outer peripheral surface of a drive shaft to be movable in a direction along an axis line of the rotation axis, the drive shaft being configured to be rotated around the rotation axis by the motive power provided from the motor, the hammer being configured to be rotated around the rotation axis along with rotation of the drive shaft.

4. The impact tool of claim 1, wherein
the hammer includes
a main hammer coupled to an outer peripheral surface of a drive shaft to be movable in a direction along an axis line of the rotation axis, the drive shaft being configured to be rotated around the rotation axis by the motive power provided from the motor, the main hammer being configured to be rotated around the rotation axis along with rotation of the drive shaft, and
a sub-hammer being restricted from moving in the direction along the axis line of the rotation axis, the sub-hammer being coupled to the main hammer to rotate together with the main hammer as the main hammer rotates around the rotation axis.

5. The impact tool of claim 1, wherein
the hammer has a peripheral edge part thicker than a center part of the hammer in a direction along an axis line of the rotation axis.

6. The impact tool of claim 1, wherein
the hammer includes a hammer body and a hammer projection protruding from a front surface of the hammer body, the front surface facing the anvil,
the anvil includes an anvil body located forward of the hammer body and an anvil projection connected to the anvil body and configured to collide with the hammer projection in a rotation direction of the hammer, and
the hammer further includes an edge part at an outer periphery of the hammer body, the edge part protruding forward as far as a front surface of the hammer projection or protruding forward farther than the hammer projection.

7. An impact tool comprising:
a motor;
a hammer configured to be rotated around a rotation axis by motive power provided from the motor; and
an anvil configured to be rotated around the rotation axis by receiving striking force from the hammer in a circumferential direction of the rotation axis,
the anvil including an anvil shaft configured to transmit the striking force to a tip tool,
a waveform, which represents a measured torsion amount of the anvil shaft during one impact for impact operation of giving the striking force to the anvil from the hammer, having a plurality of peaks, and in the one impact, rotation energy of the hammer transmitted to the anvil after a time point at which a highest peak of the plurality of peaks is measured being greater than rotation energy of the hammer transmitted to the anvil before the time point.
